(19) United States
(12) Patent Application Publication
(10) Pub. No.: US 2023/0220813 A1
(43) Pub. Date: Jul. 13, 2023

(54) COOLING STRUCTURE OF INTERNAL COMBUSTION ENGINE

(71) Applicant: TOYOTA JIDOSHA KABUSHIKI KAISHA, Toyota-shi (JP)

(72) Inventor: Masahiro OKUNO, Toyota-shi (JP)

(73) Assignee: TOYOTA JIDOSHA KABUSHIKI KAISHA, Toyota-shi (JP)

(21) Appl. No.: 18/052,958

(22) Filed: Nov. 7, 2022

(30) Foreign Application Priority Data
Jan. 7, 2022 (JP) 2022-001521

(51) Int. Cl. F02F 1/16

(52) U.S. Cl. CPC F02F 1/16

(57) ABSTRACT

A cooling structure of an internal combustion engine includes a cylinder block including a water jacket, the water jacket having a first inner wall and a second inner wall facing each other, and a spacer disposed in the water jacket, the spacer having a first surface and a second surface facing each other, wherein at least one of the first and second surfaces of the spacer, at least one of the first and second inner walls of the water jacket, or any combination thereof has a first region, a second region, and a third region, the first region is closer to a combustion chamber of the internal combustion engine than the second region, and the second region is closer to the combustion chamber than the third region, and has a larger surface roughness than the first region and the third region.

### CROSS-REFERENCE TO RELATED APPLICATION

This application is based upon and claims the benefit of priority of the prior Japanese Patent Application No. 2022-001521, filed on Jan. 7, 2022, the entire contents of which are incorporated herein by reference.

### FIELD

The present disclosure relates to a cooling structure of an internal combustion engine.

### BACKGROUND

To cool the internal combustion engine, a water jacket through which cooling water flows is provided in the cylinder block. A water jacket spacer is disposed in the water jacket to adjust the flow direction, the flow rate, and the like of the cooling water as disclosed in, for example, Japanese Patent Application Laid-Open No. 2013-079605 (Patent Document 1).

### SUMMARY

The amount of generated heat varies depending on the position in the internal combustion engine. When the cooling water is caused to flow at a constant flow rate, local supercooling may occur in a part of the internal combustion engine. Therefore, an object of the present disclosure is to provide a cooling structure of an internal combustion engine capable of inhibiting local supercooling of the internal combustion engine.

According to one aspect of the present disclosure, there is provided a cooling structure of an internal combustion engine including: a cylinder block including a water jacket, the water jacket having a first inner wall and a second inner wall facing each other; and a spacer disposed in the water jacket, the spacer having a first surface and a second surface facing each other, wherein at least one of the first and second surfaces of the spacer, at least one of the first and second inner walls of the water jacket, or any combination thereof has a first region, a second region, and a third region, wherein the first region is closer to a combustion chamber of the internal combustion engine than the second region, and wherein the second region is closer to the combustion chamber than the third region, and has a larger surface roughness than the first region and the third region.

At least one of the first and second surfaces of the spacer may have the first region, the second region, and the third region, and a recess, a protrusion, a through-hole, or any combination thereof may be provided on the at least one of the first and second surfaces of the spacer in the second region.

A plurality of the recesses arranged along a direction in which cooling water stored in the water jacket flows, a plurality of the protrusions arranged along the direction, a plurality of the through-holes arranged along the direction, or any combination thereof may be provided on the at least one of the first and second surfaces of the spacer in the second region.

The spacer may surround a bore of the cylinder block, the first surface may be located closer to the bore than the second surface, and the first surface may have the first region, the second region, and the third region.

The spacer may surround a bore of the cylinder block, the first surface may be located closer to the bore than the second surface, and the second surface may have the first region, the second region, and the third region.

At least one of the first and second inner walls of the water jacket may have the first region, the second region, and the third region, and a recess, a protrusion, or both of them may be provided on the at least one of the first and second inner walls of the water jacket in the second region.

A plurality of the recesses arranged along a direction in which cooling water stored in the water jacket flows, a plurality of the protrusions arranged along the direction, or both of them may be provided on the at least one of the first and second inner walls of the water jacket.

The water jacket may surround a bore of the cylinder block, the first inner wall may be located closer to the bore than the second inner wall, and the first inner wall may have the first region, the second region, and the third region.

### BRIEF DESCRIPTION OF THE DRAWINGS

FIG. 1A is a cross-sectional view illustrating a cooling structure of an internal combustion engine, and FIG. 1B is a plan view illustrating a cylinder block of the internal combustion engine 10;

FIG. 2A is a perspective view illustrating a spacer, and FIG. 2B is a cross-sectional view taken along line A-A in FIG. 2A;

FIG. 3A is a perspective view illustrating a spacer in accordance with a variation of the first embodiment, and FIG. 3B is a cross-sectional view taken along line B-B in FIG. 3A;

FIG. 4A is a perspective view illustrating a spacer in accordance with a second embodiment, and FIG. 4B is a cross-sectional view taken along line C-C in FIG. 4A;

FIG. 5A is a perspective view illustrating a spacer in accordance with a variation of the second embodiment, and FIG. 5B is a cross-sectional view taken along line D-D in FIG. 5A;

FIG. 6A is a perspective view illustrating a spacer in accordance with a third embodiment, and FIG. 6B is a cross-sectional view taken along line E-E in FIG. 6A; and

FIG. 7A is a side view illustrating a cylinder block in accordance with a fourth embodiment, FIG. 7B is a cross-sectional view illustrating the inner wall of the water jacket, and FIG. 7C is a cross-sectional view illustrating the inner wall of the water jacket.

### DETAILED DESCRIPTION

### First Embodiment

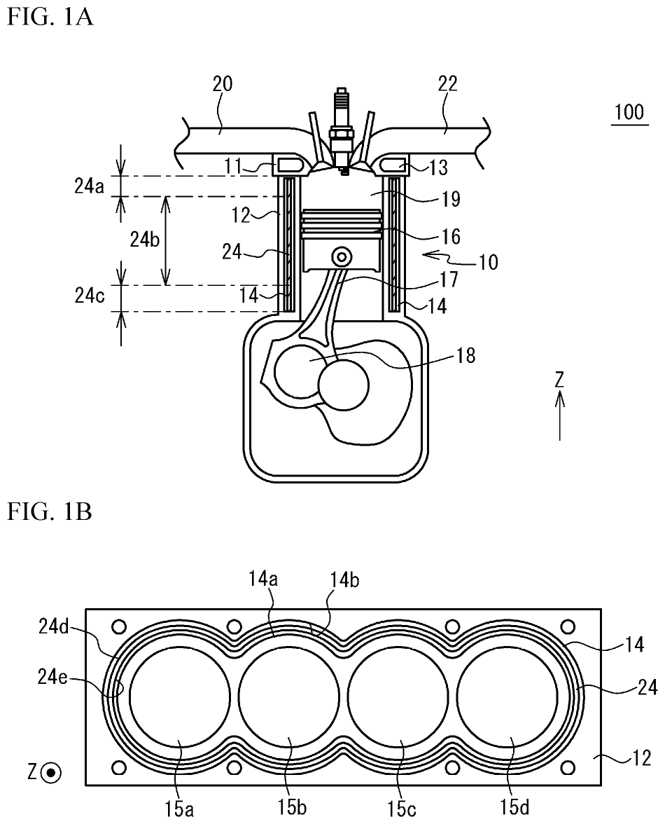

Hereinafter, a cooling structure for an internal combustion engine of the present embodiment will be described with reference to the drawings. FIG. 1A is a cross-sectional view illustrating a cooling structure 100 of an internal combustion engine, and illustrates one bore of an internal combustion engine 10. As illustrated in FIG. 1A, the internal combustion engine 10 includes a cylinder head 11 and a cylinder block 12. The cylinder head 11 and the cylinder block 12 are made of a metal such as an aluminum alloy. The cylinder head 11 is mounted to the upper side of the cylinder block 12. The Z direction is the direction in which the bore extends, and the cylinder head 11 is attached to the +Z side of the cylinder block 12.

A piston 16 is housed in the cylinder block 12. One end of a connecting rod 17 is connected to the piston 16, and the other end thereof is connected to a crankshaft 18. A combustion chamber 19 is defined by the cylinder block 12, the cylinder head 11, and the piston 16.

An intake passage 20 and an exhaust passage 22 are connected to the cylinder head 11. Air is introduced into the combustion chamber 19 from the intake passage 20. A mixture of air and fuel is combusted in the combustion chamber 19. Exhaust gas generated by the combustion is discharged through the exhaust passage 22. The combustion of the air-fuel mixture causes the piston 16 to reciprocate in the Z-axis direction, and the crankshaft 18 rotates.

The cylinder head 11 has a water jacket 13. The cylinder block 12 has a water jacket 14. The internal combustion engine 10 is cooled by circulating cooling water inside the water jackets 13 and 14. A spacer 24 is inserted into the water jacket 14. The cooling structure 100 is formed by the cylinder block 12 and the spacer 24. The thermal conductivity between the cooling water and the cylinder block 12 depends on the flow rate of the cooling water. As the flow rate increases, the thermal conductivity becomes higher. As the flow rate decreases, the thermal conductivity becomes lower.

As illustrated in FIG. 1A, the water jacket 14 and the spacer 24 extend in the Z-axis direction. The spacer 24 has three regions 24a (a first region), 24b (a second region), and 24c (a third region). The region 24a, the region 24b, and the region 24c are arranged in this order from the top of FIG. 1A. The region 24a is an upper region of the spacer 24 in the extending direction (the Z-axis direction) of the bore. The region 24c is a lower region in the Z-axis direction. The region 24b is a central region in the Z-axis direction. The region 24a is located closer to the combustion chamber 19 than the regions 24b and 24c. The region 24b is located closer to the combustion chamber 19 than the region 24c. In other words, among the three regions, the region 24a is closest to the top dead center of the piston 16. The region 24c is closest to the bottom dead center. The region 24b corresponds to a part where the piston 16 moves up and down.

FIG. 1B is a plan view illustrating the cylinder block 12 of the internal combustion engine 10. As illustrated in FIG. 1B, the cylinder block 12 has, for example, four bores 15a, 15b, 15c, and 15d. The Z-direction is the direction in which the bore extends.

The spacer 24 (a water jacket spacer) is disposed inside the water jacket 14. The water jacket 14 and the spacer 24 surround the bores 15a, 15b, 15c, and 15d.

Cooling water is introduced into the water jacket 14 from a supply port (not illustrated). The cooling water circulates inside the water jacket 14 and is discharged from a discharge port (not illustrated). The spacer 24 is provided to control the flow of the cooling water.

The water jacket 14 has inner walls 14a and 14b. The inner wall 14a is the outer wall of the bore. The inner wall 14b faces the inner wall 14a. The outer surface of the spacer 24 is referred to as a surface 24d, and the inner surface thereof is referred to as a surface 24e. The surface 24d is a surface opposite from the bore, and faces the inner wall 14b of the water jacket 14. The surface 24d and the inner wall 14b are spaced from each other. The surface 24e is a surface closer to the bore and faces the inner wall 14a of the water jacket 14. The surface 24e and the inner wall 14a are spaced from each other. The cooling water flows between the surface 24d and the inner wall 14b and between the surface 24e and the inner wall 14a.

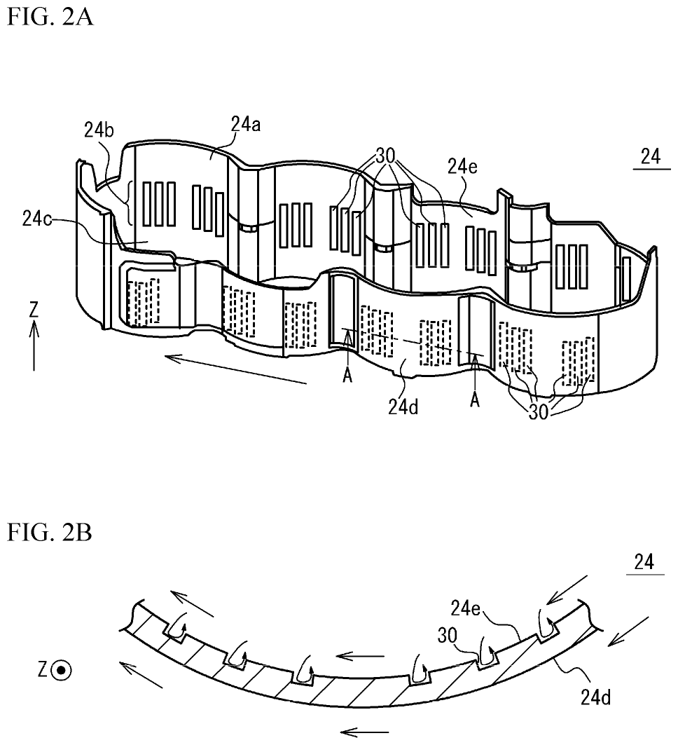

FIG. 2A is a perspective view illustrating the spacer 24. The spacer 24 is a member having a ring shape, and is formed of, for example, a resin. The cooling water flows in the direction indicated by an arrow in FIG. 2A.

The inner surface 24e of the spacer 24 has the regions 24a, 24b, and 24c. The regions 24a, 24b, and 24c extend along the circumferential direction of the spacer 24. In the region 24b, a plurality of recesses 30 are provided on the surface 24e. The recesses 30 are arranged along the direction in which the cooling water flows. No recess 30 is provided in the regions 24a and 24c.

FIG. 2B is a cross-sectional view taken along line A-A in FIG. 2A. As illustrated in FIG. 2B, the recesses 30 are provided on the surface 24e and are recessed in the thickness direction of the spacer 24. Since the recesses 30 are provided, the region 24b has a larger surface roughness than the regions 24a and 24c.

As indicated by arrows in FIG. 2B, the cooling water flows around the spacer 24. The cooling water flows into the inside of the each recess 30 and swirls. Therefore, the flow of the cooling water is disturbed, and the flow velocity is reduced as compared with the case in which no recess 30 is provided.

In the first embodiment, the surface 24e of the spacer 24 has the regions 24a, 24b, and 24c. No recess 30 is provided in the regions 24a and 24c. The regions 24a and 24b have smoother surfaces than the region 24b. The cooling water flows at a high flow rate in the regions 24a and 24b. Therefore, the thermal conductivity between the cooling water and the cylinder block 12 is increased, and the cooling performance is enhanced.

On the other hand, the recesses 30 are provided on the surface 24e in the region 24b. The region 24b has a larger surface roughness than the regions 24a and 24c. In the region 24b, the flow velocity of the cooling water is lower than in the regions 24a and 24c, and the thermal conductivity between the cooling water and the cylinder block 12 is lower. As compared with the regions 24a and 24c, heat exchange between the cooling water and the cylinder block 12 in the region 24b is suppressed, and local subcooling can be inhibited.

The air-fuel mixture is combusted in the combustion chamber 19, and thereby, heat is generated. In the internal combustion engine 10, the vicinity of the combustion chamber 19 tends to have a high temperature. As illustrated in FIG. 1A, the region 24a is closest to the combustion chamber 19 among the three regions. Therefore, it is possible to efficiently cool the cylinder block 12 by increasing the flow rate of the cooling water in the region 24a to increase the thermal conductivity. Knocking, overheating and the like can be inhibited.

As illustrated in FIG. 1A, since the region 24b is farther from the combustion chamber 19 than the region 24a, it is not a problem if the thermal conductivity therein is low. The region 24b surrounds a part of the engine 10 where the piston 16 moves up and down. By inhibiting excessive cooling in the region 24b, the temperature around the bore of the cylinder block 12 rises, and the bore expands. The expansion of the bore can reduce friction between the piston 16 and the inner wall of the bore.

As illustrated in FIG. 1B, the surface 24e of the spacer 24 faces the bore. The recesses 30 also face the bore. The flow velocity of the cooling water decreases between the spacer 24 and the bore. By inhibiting supercooling in the vicinity of the bore, friction between the piston 16 and the inner wall of the bore can be reduced.

As illustrated in FIG. 2B, since the recesses 30 are arranged along the direction in which the cooling water flows, it is possible to effectively reduce the flow velocity of the cooling water. For example, twelve recesses 30 are arranged for one bore. The number of the recesses 30 may be changed. The width and depth of the recess 30 may be determined in accordance with, for example, the size of the cylinder block 12. The number of bores may be three or less, or five or more.

### Variation

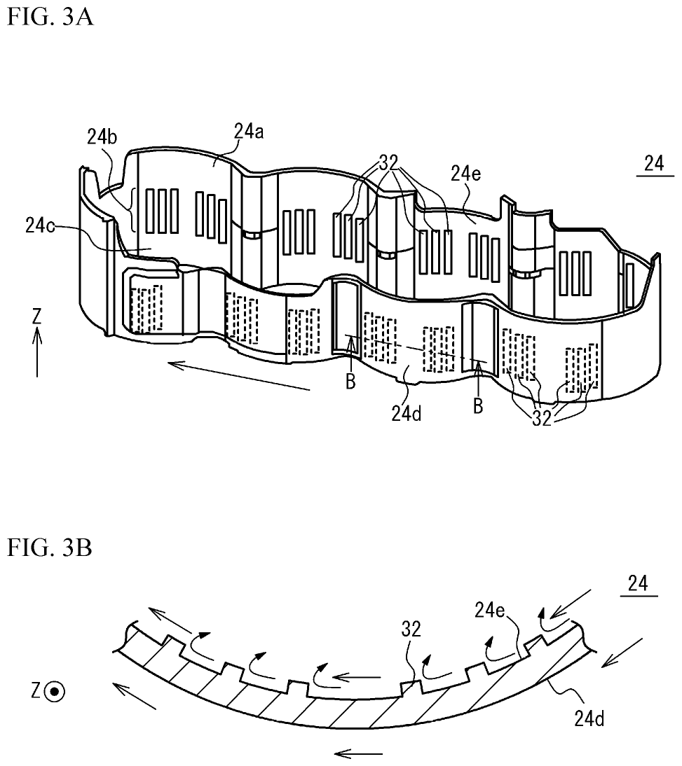

FIG. 3A is a perspective view illustrating the spacer 24 in accordance with a variation of the first embodiment. Description of the same configuration as that in the first embodiment will be omitted. As illustrated in FIG. 3A, a plurality of protrusions 32 are provided on the surface 24e in the region 24b. The protrusions 32 are arranged along the direction in which the cooling water flows. FIG. 3B is a cross-sectional view taken along line B-B in FIG. 3A. As illustrated in FIG. 3B, the protrusions 32 protrude from the surface 24e in the thickness direction of the spacer 24. Since the protrusions 32 are provided, the region 24b has a larger surface roughness than the regions 24a and 24c.

As indicated by arrows in FIG. 3B, the cooling water flows around the spacer 24. The flow of the cooling water is disturbed by the collision of the cooling water with the protrusions 32, and the flow velocity is reduced compared with that in the case in which no protrusion 32 is provided. The thermal conductivity between the cooling water and the cylinder block 12 becomes low. As compared with the regions 24a and 24c, heat exchange between the cooling water and the cylinder block 12 in the region 24b is reduced, and local supercooling can be inhibited.

The number of the protrusions 32, the width of each protrusion 32, and the amount of protrusion (height from the surface 24e) may be determined in accordance with, for example, the size of the cylinder block 12. Both the recesses 30 and the protrusions 32 may be provided on the surface 24e of the spacer 24.

### Second Embodiment

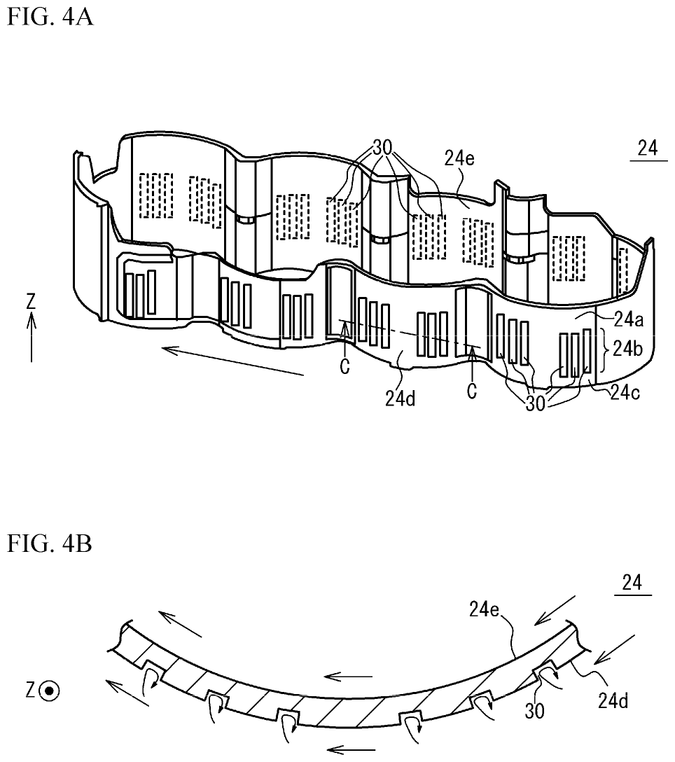

FIG. 4A is a perspective view illustrating the spacer 24 in accordance with a second embodiment. Description of the same configuration as that in the first embodiment will be omitted. As illustrated in FIG. 4A, the surface 24d of the spacer 24 has the regions 24a, 24b, and 24c. In the region 24b, a plurality of the recesses 30 are provided on the surface 24d in the region 24b. The recesses 30 are arranged along the direction in which the cooling water flows. No recess 30 is provided in the regions 24a and 24c.

FIG. 4B is a cross-sectional view taken along line C-C in FIG. 4A. As illustrated in FIG. 4B, the recesses 30 are provided on the surface 24d of the spacer 24 and are recessed in the thickness direction. Since the recesses 30 are provided, the region 24b has a larger surface roughness than the regions 24a and 24c.

As indicated by arrows in FIG. 4B, the cooling water flows around the spacer 24. The cooling water flows into the inside of each recess 30 and swirls. Therefore, the flow of the cooling water is disturbed, and the flow velocity is reduced as compared with that in the case in which no recess 30 is provided.

According to the second embodiment, the recesses 30 are provided on the surface 24d in the region 24b. The region 24b has a larger surface roughness than the regions 24a and 24c. In the region 24b, the flow velocity of the cooling water is lower than those in the regions 24a and 24c, and the thermal conductivity between the cooling water and the cylinder block 12 is lower. As compared with the regions 24a and 24c, heat exchange between the cooling water and the cylinder block 12 in the region 24b is reduced, and local supercooling can be inhibited.

### Variation

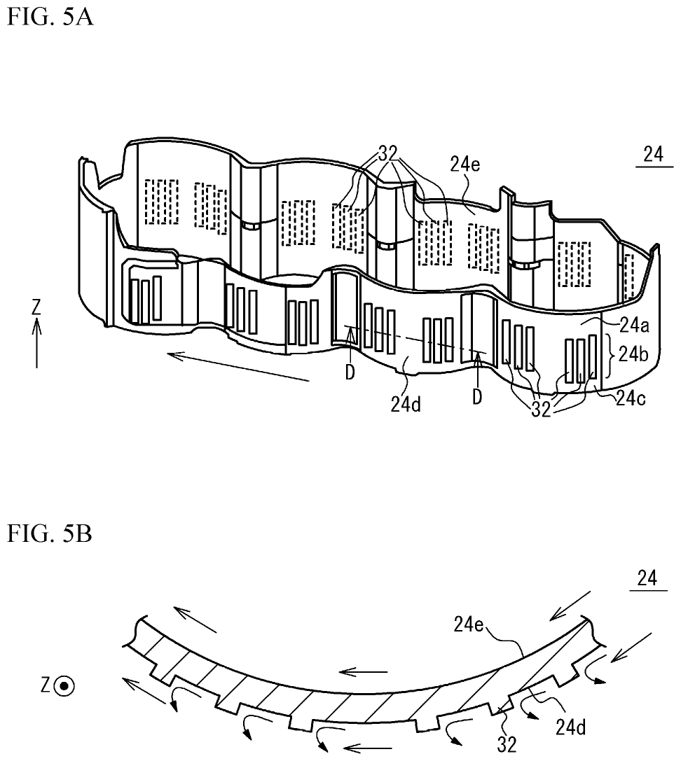

FIG. 5A is a perspective view illustrating the spacer 24 in accordance with a variation of the second embodiment. Description of the same configuration as that in the second embodiment will be omitted. As illustrated in FIG. 5A, a plurality of the protrusions 32 are provided on the surface 24d in the region 24b. FIG. 5B is a cross-sectional view taken along line D-D in FIG. 5A. As illustrated in FIG. 5B, the protrusions 32 protrude from the surface 24d in the thickness direction of the spacer 24.

As indicated by arrows in FIG. 5B, the cooling water flows around the spacer 24. The flow of the cooling water is disturbed by the collision of the cooling water with the protrusions 32, and the flow velocity is reduced compared with that in the case in which no protrusion 32 is provided. The thermal conductivity between the cooling water and the cylinder block 12 is reduced. As compared with the regions 24a and 24c, heat exchange between the cooling water and the cylinder block 12 in the region 24b is reduced, and local supercooling can be inhibited.

The recesses 30 and the protrusions 32 may be provided on either one of the surfaces 24d and 24e of the spacer 24, or the recesses 30 and the protrusions 32 may be provided on both the surfaces 24d and 24e.

### Third Embodiment

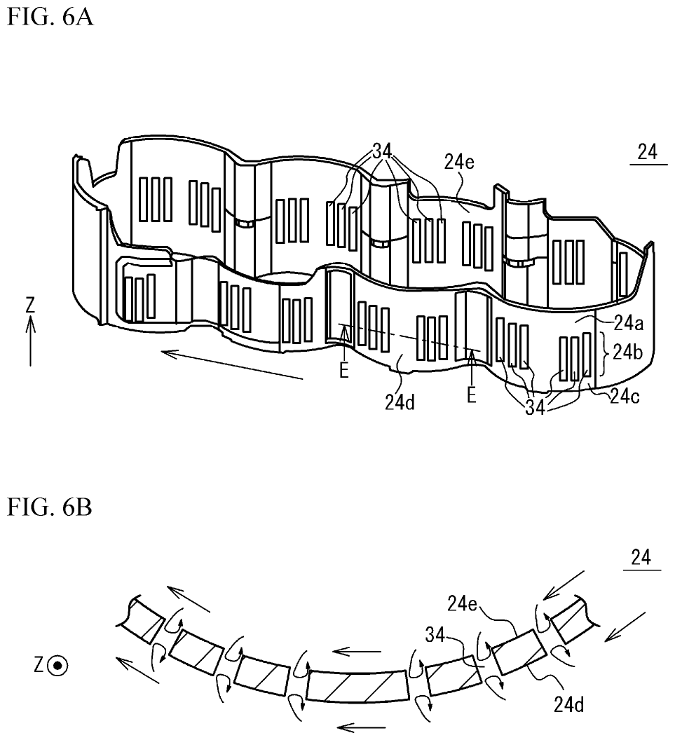

FIG. 6A is a perspective view illustrating the spacer 24 in accordance with the third embodiment. Description of the same configuration as those of the first embodiment and the second embodiment will be omitted. As illustrated in FIG. 6A, a plurality of through-holes 34 are provided in the region 24b of the spacer 24. The through-holes 34 are arranged along the direction in which the cooling water flows.

FIG. 6B is a cross-sectional view taken along line E-E in FIG. 6A. As illustrated in FIG. 6B, each through-hole 34 extends from the surface 24d to the surface 24e of the spacer 24 and penetrates through the spacer 24 in the thickness direction. Since the through-holes 34 are provided, the region 24b has a larger surface roughness than the regions 24a and 24c. As indicated by arrows in FIG. 6B, the cooling water flows around the spacer 24. The flow of the cooling water is disturbed by the through-holes, and the flow velocity is reduced compared with that in the case in which no through-hole is provided.

In the third embodiment, the region 24b of the spacer 24 has the through-holes 34 and has a larger surface roughness than the regions 24a and 24c. In the region 24b, the flow velocity of the cooling water is lower than in the regions 24a and 24c. The thermal conductivity between the cooling water and the cylinder block 12 is reduced. As compared with the regions 24a and 24c, heat exchange between the cooling water and the cylinder block 12 in the region 24b is reduced, and local supercooling can be inhibited.

The region 24b of the spacer 24 may have at least one of the recess 30, the protrusion 32, or the through-hole 34. The region 24b may have the recess 30 and the protrusion 32, may have the recess 30 and the through-hole 34, or may have the protrusion 32 and the through-hole 34. The region 24b may have all of the recess 30, the protrusion 32, and the through-hole 34.

### Fourth Embodiment

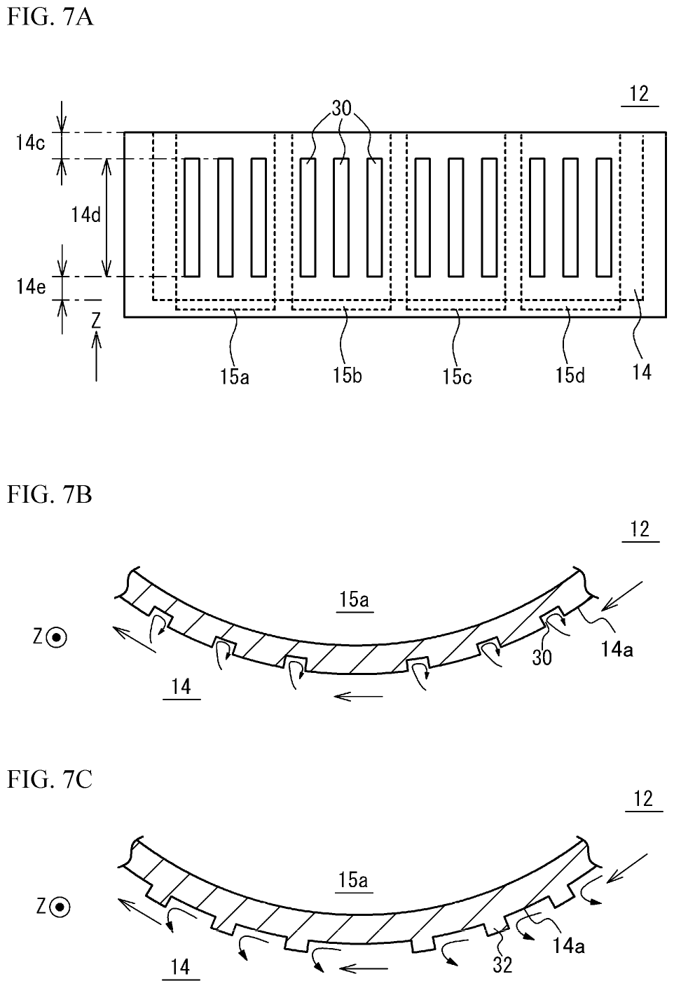

FIG. 7A is a side view illustrating the cylinder block 12 in accordance with a fourth embodiment. Description of the same configurations as those in the first to third embodiments will be omitted. The inside wall 14a (the outer wall of the bore) of the water jacket 14 illustrated in FIG. 1B has three regions 14c, 14d, and 14e as illustrated in FIG. 7A.

The region 14c (a first region), the region 14d (a second region), and the region 14e (a third region) are arranged in this order from the top of FIG. 7A. The region 14c is an upper region of the cylinder block 12 in the extending direction (the Z-axis direction) of the bore. The region 14e is a lower region in the Z-axis direction. The region 14d is a central region in the Z-axis direction. The region 14c is located closer to the combustion chamber 19 illustrated in FIG. 1A than the regions 14d and 14e. The region 14d is located closer to the combustion chamber 19 than the region 14e. In other words, among the three regions, the region 14c is closest to the top dead center of the piston 16. The region 14e is closest to the bottom dead center. The region 14d corresponds to a portion where the piston 16 moves up and down.

FIG. 7B is a cross-sectional view illustrating the inner wall 14a of the water jacket 14. The lower side of FIG. 7B is the water jacket 14, and the upper side is the bore (for example, the bore 15a). The inner wall 14a of the water jacket 14 separates the water jacket 14 from the bore 15a. As illustrated in FIG. 7B, the recesses 30 are provided on the inner wall 14a of the water jacket 14. Each recess 30 is recessed in the thickness direction of the inner wall. A plurality of the recesses 30 are arranged along the direction in which the cooling water flows. The cooling water flows as indicated by arrows in FIG. 7B. The cooling water flows into the inside of each recess 30 and swirls. Therefore, the flow of the cooling water is disturbed, and the flow velocity becomes lower than that in the case in which no recess 30 is provided.

In the fourth embodiment, the recesses 30 are provided on the inner wall 14a in the region 14d. The region 14d has a larger surface roughness than the regions 14c and 14e. In the region 14d, the flow velocity of the cooling water is lower than that in the regions 14c and 14e. The thermal conductivity between the cooling water and the cylinder block 12 is reduced. Compared with the regions 14c and 14e, the heat exchange between the cooling water and the cylinder block 12 in the region 14d is reduced, and local supercooling can be inhibited.

### Variation

FIG. 7C is a cross-sectional view illustrating the inner wall 14a of the water jacket 14. The description of the same configuration as that of the fourth embodiment will be omitted. As illustrated in FIG. 7C, a plurality of the protrusions 32 are provided on the inner wall 14a in the region 14d. Each protrusion 32 protrudes in the thickness direction of the inner wall.

The cooling water flows as indicated by arrows in FIG. 7C. The flow of the cooling water is disturbed by the collision of the cooling water with the protrusions 32, and the flow velocity becomes lower than that in the case in which no protrusion 32 is provided. The thermal conductivity between the cooling water and the cylinder block 12 is reduced. Compared with the regions 14c and 14e, the heat exchange between the cooling water and the cylinder block 12 in the region 14d is reduced, and local supercooling can be inhibited.

The inner wall 14a of the water jacket 14 is only required to have at least one of the recess 30 or the protrusion 32. The recess 30 and the protrusion 32 may be provided on the inner wall 14b. As illustrated in FIG. 7B and FIG. 7C, it is preferable to provide the recess 30 and the protrusion 32 on the inner wall 14a. As illustrated in FIG. 1B, of the inner walls 14a and 14b, the inner wall 14a is closer to the bore, and the inner wall 14b is farther from the bore. By increasing the surface roughness of the inner wall 14a, the flow velocity of the cooling water can be reduced in the vicinity of the bore, and supercooling can be effectively inhibited.

It is only required that at least one of the surface of the spacer 24 or the inner wall of the water jacket 14 has three regions and the surface roughness of the central region is large. For example, the surface of the spacer 24 may have the region 24b having a large surface roughness, and the inner wall of the water jacket 14 may also have the region 14d having a large surface roughness.

Although some embodiments of the present invention have been described in detail, the present invention is not limited to the specific embodiments but may be varied or changed within the scope of the present invention as claimed.

What is claimed is:

1. A cooling structure of an internal combustion engine comprising:
a cylinder block including a water jacket, the water jacket having a first inner wall and a second inner wall facing each other; and
a spacer disposed in the water jacket, the spacer having a first surface and a second surface facing each other,
wherein at least one of the first and second surfaces of the spacer, at least one of the first and second inner walls of the water jacket, or any combination thereof has a first region, a second region, and a third region,
wherein the first region is closer to a combustion chamber of the internal combustion engine than the second region, and
wherein the second region is closer to the combustion chamber than the third region, and has a larger surface roughness than the first region and the third region.

2. The cooling structure of the internal combustion engine according to claim 1,
wherein at least one of the first and second surfaces of the spacer has the first region, the second region, and the third region, and
wherein a recess, a protrusion, a through-hole, or any combination thereof is provided on the at least one of the first and second surfaces of the spacer in the second region.

3. The cooling structure of the internal combustion engine according to claim 2, wherein a plurality of the recesses arranged along a direction in which cooling water stored in the water jacket flows, a plurality of the protrusions arranged along the direction, a plurality of the through-holes arranged along the direction, or any combination thereof are provided on the at least one of the first and second surfaces of the spacer in the second region.

4. The cooling structure of the internal combustion engine according to claim 1,
wherein the spacer surrounds a bore of the cylinder block,
wherein the first surface is located closer to the bore than the second surface, and
wherein the first surface has the first region, the second region, and the third region.

5. The cooling structure of the internal combustion engine according to claim 1,
wherein the spacer surrounds a bore of the cylinder block,
wherein the first surface is located closer to the bore than the second surface, and
wherein the second surface have the first region, the second region, and the third region.

6. The cooling structure of the internal combustion engine according to claim 1,
wherein at least one of the first and second inner walls of the water jacket has the first region, the second region, and the third region, and
wherein a recess, a protrusion, or both of them are provided on the at least one of the first and second inner walls of the water jacket in the second region.

7. The cooling structure of the internal combustion engine according to claim 6, wherein a plurality of the recesses arranged along a direction in which cooling water stored in the water jacket flows, a plurality of the protrusions arranged along the direction, or both of them are provided on the at least one of the first and second inner walls of the water jacket in the second region.

8. The cooling structure of the internal combustion engine according to claim 1,
wherein the water jacket surrounds a bore of the cylinder block,
wherein the first inner wall is located closer to the bore than the second inner wall, and
wherein the first inner wall has the first region, the second region, and the third region.
